(19) United States
(12) Patent Application Publication
(10) Pub. No.: US 2020/0255259 A1
(43) Pub. Date: Aug. 13, 2020

(54) ELEVATOR SYSTEM AND METHOD FOR OPERATING AN ELEVATOR SYSTEM

(71) Applicants: THYSSENKRUPP ELEVATOR AG, Essen (DE); thyssenkrupp AG, Essen (DE)

(72) Inventors: Stefan KNEISLER, Adelberg (DE); Daniel JOHNEN, Stetten (DE)

(73) Assignees: THYSSENKRUPP ELEVATOR AG, Essen (DE); thyssenkrupp AG, Essen (DE)

(21) Appl. No.: 16/636,971

(22) PCT Filed: Aug. 14, 2018
(86) PCT No.: PCT/EP2018/072022

§ 371 Date: Feb. 6, 2020

(30) Foreign Application Priority Data
Aug. 14, 2017 (DE) 10 2017 118 507.0

(51) Int. Cl. B66B 5/02; B66B 1/30; B66B 1/32; B66B 7/12; B66B 11/04

(52) U.S. Cl. CPC B66B 5/02; B66B 1/30; B66B 11/0407; B66B 7/1246; B66B 1/32

(57) ABSTRACT

An elevator system may include a ropeless direct drive, a rail system, an elevator car, and a brake. The elevator system may also include a component on which there is arranged a sensor for sensing oscillations. The elevator system further comprises a processing unit for calculating counter-oscillations on the basis of the sensed oscillations. The elevator system also include means for generating the calculated counter-oscillations, which may also be disposed on the component. A corresponding method may involve sensing oscillations outside an elevator car, calculating counter-oscillations based on sensed oscillations, and generating the calculated counter-oscillations outside the elevator car.

The present invention relates to an elevator system and to a method for operating an elevator system.

### PRIOR ART

Elevator systems are commonly used to transport passengers to different floors within a building. This creates disturbing noise such as, for example, engine noise, rattling noises and wind noise. These noises are transmitted, for example via wall elements, into the interior of an elevator car. Furthermore, such noises are also propagated, via the wall of an elevator shaft, into the interior of a building.

Elevators in very tall buildings should achieve high transportation capacities while requiring as little space as possible. This requirement can be met, for example, by moving several elevator cars at high speeds in one elevator shaft with the lowest possible car weight. For this purpose, it is expedient for the elevator cars to be driven directly, without a rope. A linear motor, in particular, is suitable for direct driving of a ropeless elevator.

However, the noise produced by a linear motor is a particular problem, particularly if the motor is fixed directly to the elevator car. Since a direct drive for elevators should have at least the same travel characteristics and no higher noise level in the elevator car than conventional high-quality traction elevators, the linear motor drive of the elevators is required to generate as little vibration and noise as possible.

WO 98/35904 discloses an elevator device having a linear drive, the stator windings, which realize the primary coils, or the primary part, of the linear drive, being attached to a wall of the elevator shaft, and the excitation magnets, which form the secondary part of the linear drive, being attached to the elevator car.

The object of the present invention is to reduce the disturbing noise and vibrations of an elevator system.

### DISCLOSURE OF THE INVENTION

Proposed according to the invention is an elevator system having the features of claim 1, and a method for operating an elevator system having the features of claim 11.

The elevator system according to the invention, having a drive realized as a ropeless direct drive, comprises at least one rail system, at least one elevator car and at least one brake, wherein the elevator system comprises at least one component outside of the elevator car on which there is arranged at least one sensor for sensing oscillations, wherein the elevator system further comprises at least one processing unit for calculating counter-oscillations on the basis of the sensed oscillations, wherein at least one means for generating the calculated counter-oscillations is arranged on the at least one component. The means for generating the calculated counter-oscillations in this case is, in particular, an oscillation damper.

In the case of such elevator systems, the drive, the rail system and the brake are the main sources of disturbing noise. The fact that, for example, at least one sensor is arranged on such a component outside of the elevator car ensures, according to the invention, that oscillations such as vibrations and/or sound are sensed directly at the source. Since at least one means for generating the calculated counter-oscillations such as, for example, counter-sound and/or counter-vibrations, is provided on the at least one component, according to the invention disturbing noises and/or disturbing vibrations are eliminated as close as possible to the source at which they are generated or occur, or at least reduced in such a manner that they can scarcely be propagated into the interior of the elevator car or, via the wall of the elevator shaft, into the interior of the building.

In particular, therefore, according to the invention the elevator car is to a large extent acoustically decoupled from disturbing noise produced at the drive, rail system or brake.

It is conceivable for a plurality of such sensors, which may be realized as vibration sensors and/or sound sensors, to be provided. Advantageously, these sensors are arranged at regular intervals on the rail system. It is also conceivable for them to be arranged at a plurality of positions of the drive and/or brake. They may also be arranged, advantageously, on the elevator car or a slide sledge or of an elevator car. It proves to be advantageous to provide a plurality of means for generating the calculated counter-oscillations. Advantageously, such means are arranged at regular intervals, i.e. in particular with uniform vertical spacing from each other, on the rail system. It is also advantageously possible to arrange these means at a plurality of points on the motor and/or brake, sledge and/or elevator car.

A further advantageous design provides that the means for generating the calculated counter-oscillations and/or the at least one sensor for sensing oscillations are/is arranged on a mounting of the rail system by means of which rails of the rail system are fixed, in particular between the shaft wall and the rail. The mounting and rail system in this case are advantageously coupled in respect of oscillation. In particular, it is provided that in each case at least one sensor for sensing oscillations and/or one means for generating the calculated counter-oscillations are/is arranged on a multiplicity of mountings, in particular on all mountings. The advantage of arrangement on the mountings is that, in particular, unused space is available here for arrangement, and arrangement is possible without the means for generating the calculated counter-oscillations and/or the at least one sensor protruding into the movement range of the roller guide. In particular, it may also be provided that, as an alternative or in addition to the rail mountings, supporting elements, for receiving the means for generating the calculated counter-oscillations and/or the at least one sensor for sensing oscillations are arranged on the rails. These supporting elements in this case are advantageously arranged, coupled in respect of oscillation, on the rail system, in particular outside of the movement ranges of the roller guides. Advantageously, the processing unit, which calculates the necessary counter-oscillations, is designed, in particular, to compensate a possible oscillation deviation between the rail system and the rail mounting, or supporting element. In particular, it is provided that the processing unit is designed to be self-learning for this purpose, and in particular has a feedback control system that identifies when counter-oscillations do not sufficiently compensate the sensed oscillations, and adjusts the generation of the counter-oscillations accordingly. In particular, for this purpose there may be arranged on the rail system at least one further reference sensor, which provides the processing means with oscillation data, in particular in addition to the at least one sensor for sensing oscillations.

Advantageously, at least one means for generating the calculated counter-oscillations is arranged in a respective shaft head, and at least one means for generating the calculated counter-oscillations is arranged in a respective shaft pit, in particular at the suspension points of the rails of the rail system. In particular, it is provided that the respective means for generating the calculated counter-oscillations are in this case arranged on the mounting at that location, on which the rails are suspended. Advantageously, the sensors for sensing oscillations are also arranged at the respective suspension points of the rail system, in particular in the respective shaft head and in the respective shaft pit.

Another advantageous design provides for the rail system to be divided into a plurality of rail segments, a rail segment comprising, in particular, at least one rail line, i.e. a corresponding element. Advantageously assigned to each rail segment in this case is at least one sensor for sensing oscillations, and at least one means for generating the calculated counter-oscillations, advantageously arranged on a holding element of the rail segment. Advantageously, the rail segments in this case are decoupled from each other in respect of oscillation. Thus, advantageously, only oscillations generated on the respective rail segment must be damped. Advantageously in this case, the effects upon a rail segment caused by oscillations from adjacent rail segments are reduced.

Preferably, at least one means for generating the calculated counter-oscillations is assigned to each sensor. It is also conceivable to provide several processing units, to calculate counter-oscillations for sensed oscillations. Advantageously, one processing unit may calculate counter-oscillations for a plurality of sensors. In particular, it is provided that the number of sensors for sensing oscillations is greater than the number of means for generating the calculated counter-oscillations. Advantageously, when a processing unit receives from a plurality of sensors, in particular at least two sensors, the necessary counter-oscillations for compensating the sensed oscillations can be calculated more precisely, and thus an improved oscillation damping can be achieved. An advantageous ratio of sensors for sensing oscillations to means for generating the calculated counter-oscillations is at least 2:1 or greater. In particular, one design provides that a means for generating the calculated counter-oscillations generates the counter-oscillations on the basis of the data of a plurality of sensors, and in particular it may be provided that the same sensor provides data for a plurality of means for generating the calculated counter-oscillations.

Preferably, the at least one component on which the at least one sensor for sensing oscillations and/or the at least one means for generating the calculated counter-oscillations is arranged is selected from the drive, the rail system and the brake. However, this is not to be understood in a restrictive manner. Thus, for example, an exterior of an elevator car or a slide, or sledge, of an elevator car is also to be understood as a component in this sense.

In a further advantageous design of the invention, the at least one means for generating the calculated counter-oscillations is arranged at a predefined distance, in particular a predefined maximum distance, from the sensor. For example, the means for generating the calculated counter-oscillations is arranged at a distance of between 1 cm and 30 cm, preferably between 2 cm and 10 cm, for example 5 cm, from a nearest sensor. Such a spatial proximity allows particularly precise sensing, and therefore also particularly effective elimination, or at least reduction, of the disturbing noises and/or disturbing vibrations close to the source where they are generated, since counter-oscillations can be calculated very accurately if the generation of the counter-oscillations is effected close to the sensor.

Preferably, the at least one sensor is selected from a vibration sensor and a sound sensor. This is advantageous because sound and vibrations are the main sources of disturbance.

In another advantageous embodiment of the invention, the at least one sensor is realized as a magnetic sensor. Magnetic sensors are used, for example, in microphones, and are very well suited for sensing oscillations such as vibrations and sound. They are particularly robust and durable.

In another advantageous embodiment, the at least one sensor is designed as a capacitive sensor. Capacitive sensors are also used for microphones, and are well suited for sensing oscillations such as vibrations and sound. They also have the advantage that they require little installation space.

In another advantageous design, at least one sensor is realized as a piezoelectric sensor. Piezoelectric sensors combine high accuracy with robustness. A particular advantage is that they are insensitive to magnetic fields and radiation, which is particularly advantageous for use near the coil elements of a linear drive.

In another advantageous embodiment, at least one sensor is designed as a micro-electromagnetic sensor, or MEMS sensor. MEMS sensors are usually made of silicon. These sensors include spring-mass systems, in which the springs are silicon bars of only a few micrometers wide, and the mass is also made of silicon. Due to the deflection during acceleration, a change in electrical capacitance can be measured between the spring-mounted part and a fixed reference electrode. MEMS sensors have the advantage that they are very small in size, and can therefore also be installed, for example, in inaccessible places in an elevator system, for example, in accessible locations in an elevator shaft.

In another advantageous embodiment of the invention, the at least one sensor is realized as a resistive sensor. The operating principle of resistive sensors is that the ohmic resistance of the sensor changes as a function of measured variables such as, for instance, length, temperature or mechanical strain. Resistive sensors can be provided at very low cost.

Advantageously, the means for generating the calculated counter-oscillations is realized as an actuator. For example, an acoustic and/or vibration transducer is conceivable as an actuator. This proves to be advantageous because an actuator can be selectively controlled as a separate element.

In another advantageous embodiment, the at least one actuator is realized as a magnetic actuator. Magnetic actuators are reliable, robust and durable.

In another advantageous embodiment of the invention, the at least one actuator is realized as a piezoelectric actuator. Piezoelectric actuators are also suitable as vibration and/or acoustic transmitters. Their operation is usually more precise than that of magnetic actuators, and at the same time they are similarly robust and not susceptible to magnetic interference fields.

In another advantageous embodiment, the ropeless direct drive is designed as a linear drive. This is advantageous because, as already described above, linear drives in particular are particularly susceptible to disturbing noise, and suppression of disturbing noise by counter-oscillations such as counter-sound and/or counter-vibrations is used here to particular advantage.

In particular, it is provided that the at least one elevator car is guided on the at least one rail system by means of a rucksack suspension. This means, in particular, that the rails of the rail system are all aligned, or arranged, with respect to a common side of the elevator car. This is advantageous, in particular, so that fixed vertical rails of the rail system do not obstruct the horizontal travel path of the elevator car when it is being moved horizontally. Such a backpack suspension is disclosed, for example, in the publication WO 2017/174464, which is hereby referenced in its entirety.

In a further advantageous design of the invention, the means for generating the calculated counter-oscillations comprise at least one coil element of the drive, and is configured in such a manner that the counter-oscillations are modulated onto the control of the coil element. In this way it is possible, in particular, to counteract disturbing low-frequency noise and vibrations of electromagnets, sometimes also referred to as “humming”, advantageously directly at the location at which the disturbing oscillations such as disturbing noise and/or disturbing vibrations occur.

According to another aspect of the invention, a method for operating an elevator system having a ropeless direct drive is proposed, wherein oscillations outside of an elevator car are sensed, counter-oscillations are calculated on the basis of the sensed oscillations, and the calculated counter-oscillations are generated outside of the elevator car. In particular, the oscillations are sensed by means of at least one sensor, and the counter-oscillations are generated by means of at least one means for generating counter-oscillations. Preferably, sensors and means for generating counter-vibrations that are respectively assigned to each other have a predefined distance from each other, as already explained above. In this way, disturbing noises that originate outside of an elevator car are advantageously eliminated, or at least greatly reduced, close to the source. Further advantages and designs of the invention are given by the description and the accompanying drawing.

It is understood that the features cited above and those yet to be explained in the following are applicable, not only in the respectively specified combination, but also in other combinations or considered alone, without departure from the scope of the present invention.

The invention is represented schematically in the drawing, on the basis of an exemplary embodiment, and described in the following with reference to the drawing.

### DESCRIPTION OF THE FIGURES

FIG. 1 shows a preferred embodiment of an elevator system according to the invention, in a schematic lateral sectional view.

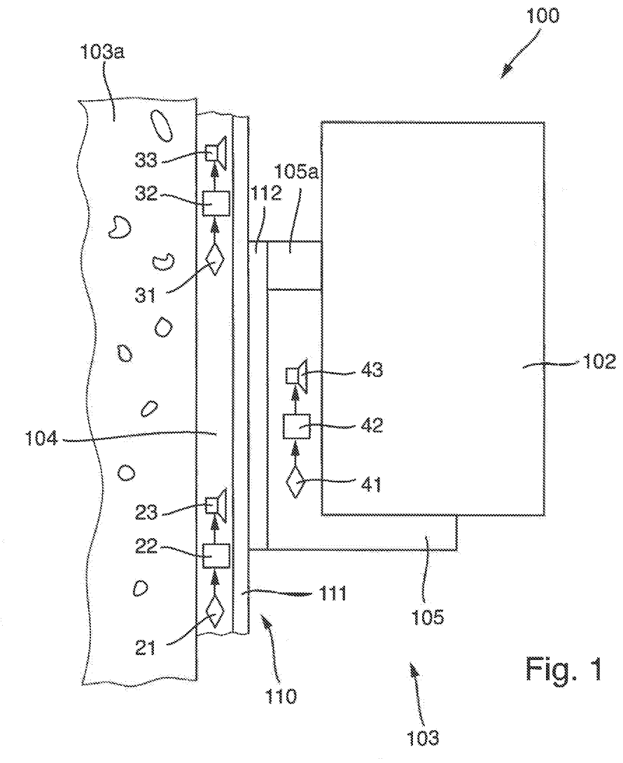

In FIG. 1, an embodiment of an elevator system according to the invention is denoted as a whole by the reference 100.

The elevator system comprises a rail system 104 attached to a shaft wall 103a of an elevator shaft 103, and an elevator car 102 that can travel vertically along the rail system in the elevator shaft 103.

The rail system 104 comprises, for example, guide rails, which are not represented in detail in FIG. 1.

The elevator car 102 comprises a slide, or sledge 105, that acts in combination with the guide rails to guide the elevator car along the rail system 104, in a manner known per se.

The represented elevator system has, as a drive, a linear drive 110. This linear drive comprises, as a primary part 111, rows of stator windings, which extend along the rail system 104 and which are arranged at a distance apart from and parallel to each other, and which project perpendicularly from a stator carrier, which is held, for example by means of anchorages, on the shaft wall 3a of the elevator shaft 3. Such primary parts 111 of linear drives are known per se, and are not explained in detail here.

On the slide 105, as secondary part 112 of the linear drive 110, there is a series of excitation magnets of alternating polarity, which are located opposite the stator windings of the primary part 111 at a predefined distance. The slide 105 also has a braking means 105a (represented in purely schematic form). This braking means may be realized, for example, by appropriate control of the excitation magnets of the secondary part 112 of the linear drive.

As is also known, a travelling magnetic field is generated in the rows of stator windings of the primary part 111 for the purpose of driving the elevator car 102. As a result, the excitation magnets of the secondary part 112 of the linear drive exert a thrust force, in the vertical direction, upon the slide 105, together with the elevator car 102. The elevator car 102 can thus move up and down along the rail system 104 in the elevator shaft 103 by means of the linear motor 110 together with the slide 105.

Provided at regular intervals on the rail system 104 are sensors for sensing oscillations such as, in particular, sound and/or vibrations. FIG. 1 shows two such sensors 21, 31. Assigned to the respective sensors 21, 31 are processing units 22, 32, which are realized in such a manner that, on the basis of the sensed oscillations, they calculate suitable counter-oscillations in order to minimize the noise development in the car 102 and/or in a building in which shaft 103 is provided. In this case, it is possible to provide only one processing unit for a plurality or all of the respective sensors.

Furthermore, an actuator 23, 33 is provided in the vicinity of each sensor 21, 31, for example at a maximum distance of 5 cm. Such actuators are designed to generate the respective counter-sound and/or counter-vibrations calculated by the processing unit.

Further corresponding sensors, processing units and actuators 41, 42, 43 are realized on the slide 105 according to the design shown. In particular, these components realized on the slide may be provided on the secondary part 112 of the linear drive.

Further sensors, processing units and actuators may also be realized on the primary part 110 of the linear drive.

In particular, such sensors, processing units and actuators may also be provided on the brake 105a, i.e. in particular the excitation magnets of the secondary part 112 of linear drive 110.

By means of the invention, the elevator car 102 can be effectively decoupled from disturbing noises that occur in the rail system 104, the drive 110 and/or the braking means 105a.

In a current development, elevator systems are being designed in which a plurality of elevator cars are in each case provided in a plurality of parallel shafts. Moreover, there are elevator systems in which elevator cars can change back and forth between two adjacent shafts. In this case, advantageously, linear drives having so-called changeover units (also known as exchangers) are used, by means of which an elevator car can be moved from one shaft, via a changeover shaft, to another shaft. In practice, it has proven advantageous for sensors and actuators, for generating calculated counter-oscillations, to be arranged close to such exchangers, since here low-frequency disturbing noises occurring in practice can be compensated very effectively. This measure can significantly reduce, in particular, disturbing noises that occur when an elevator car is being unlocked or locked, from or at an exchanger.

### LIST OF REFERENCES

100 elevator system
102 elevator car
103 elevator shaft
103a shaft wall
104 rail system
105 slide (sledge)
105a braking means
110 linear drive
111 primary part
112 secondary part
21 first sensor
22 first processing unit
23 first actuator
31 second sensor
32 second processing unit
33 second actuator
41 third sensor
42 third processing unit
43 third actuator

1.-20. (canceled)

21. An elevator system comprising:
a ropeless direct drive;
a rail system;
an elevator car;
a brake;
a sensor for sensing oscillations disposed on a component outside the elevator car;
a processing unit for calculating counter-oscillations based on sensed oscillations; and
means for generating the calculated counter-oscillations disposed on the component.

22. The elevator system of claim 21 wherein the ropeless direct drive is the component.

23. The elevator system of claim 21 wherein the brake is the component.

24. The elevator system of claim 21 wherein the rail system is the component.

25. The elevator system of claim 21 wherein the component is a holding element of the rail system.

26. The elevator system of claim 21 wherein the means for generating the calculated counter-oscillations is disposed at a predefined distance from the sensor.

27. The elevator system of claim 21 wherein the sensor is a vibration sensor or a sound sensor.

28. The elevator system of claim 21 wherein the sensor is a magnetic sensor, a capacitive sensor, a piezoelectric sensor, a MEMS sensor, or a resistive sensor.

29. The elevator system of claim 21 wherein the means for generating the calculated counter-oscillations is an actuator.

30. The elevator system of claim 29 wherein the actuator is a magnetic actuator or a piezoelectric actuator.

31. The elevator system of claim 21 wherein the ropeless direct drive is a linear drive.

32. The elevator system of claim 31 wherein the means for generating the calculated counter-oscillations comprises a coil element of the linear drive and is configured such that the counter-oscillations are modulated onto a control of the coil element.

33. The elevator system of claim 21 wherein the elevator car is guided by way of a rucksack suspension on the rail system.

34. The elevator system of claim 21 wherein the sensor is one of a plurality of sensors for sensing oscillations, wherein the means for generating the calculated counter-oscillations is one of a plurality of means for generating the calculated counter-oscillations, wherein a quantity of the plurality of sensors is greater than a quantity of the plurality of means for generating the calculated counter-oscillations.

35. The elevator system of claim 21 wherein at least one of:
the sensor and/or the means for generating the calculated counter-oscillations is disposed on a suspension of the rail system in a shaft pit of the elevator system, or
the sensor and/or the means for generating the calculated counter-oscillations is disposed on a suspension of the rail system in a shaft head of the elevator system.

36. A method for operating an elevator system having a ropeless direct drive, the method comprising:
sensing oscillations outside an elevator car;
calculating counter-oscillations based on sensed oscillations; and
generating the calculated counter-oscillations outside the elevator car.

37. The method of claim 36 wherein the oscillations are sensed by a sensor disposed on a component outside the elevator car.

38. The method of claim 36 wherein the counter-oscillations are calculated by a processing unit.

39. The method of claim 36 wherein the counter-oscillations are generated by means for generating the calculated counter-oscillations.

40. The method of claim 36 performed by an elevator system comprising:
a ropeless direct drive;
a rail system;
an elevator car;
a brake;
a sensor for sensing oscillations disposed on a component outside the elevator car;
a processing unit for calculating counter-oscillations based on sensed oscillations; and
means for generating the calculated counter-oscillations disposed on the component.
